(19) United States
(12) Patent Application Publication
(10) Pub. No.: US 2023/0152871 A1
(43) Pub. Date: May 18, 2023

(54) ELECTRONIC DEVICE AND CONNECTING DEVICE

(71) Applicant: ASUSTeK COMPUTER INC., Taipei (TW)

(72) Inventor: Jian-Hui Lee, Taipei (TW)

(21) Appl. No.: 17/954,601

(22) Filed: Sep. 28, 2022

(30) Foreign Application Priority Data
Nov. 16, 2021 (TW) 110142653

(51) Int. Cl. G06F 1/26; G06F 1/3215; G06F 13/42

(52) U.S. Cl. CPC G06F 1/266; G06F 1/3215; G06F 13/4282

(57) ABSTRACT

An electronic device is connected to a second electronic device with a second universal serial bus (USB) Type-C port and a second power delivery controller through a connecting device. In the electronic device, a first power delivery controller is connected to a first USB Type-C port, so that the first power delivery controller communicates with the second power delivery controller to generate transmission handshaking information through the first USB Type-C port, the connecting device, and the second USB Type-C port. An analysis module is electrically connected to the first power delivery controller, to determine at least one function type transmissible between the electronic device and the second electronic device according to the transmission handshaking information. A reminder device is electrically connected to the analysis module and used for indicating the at least one function type supportable between the electronic device and the second electronic device.

### CROSS-REFERENCE TO RELATED APPLICATION

This application claims the priority benefit of Taiwan application serial No. 110142653, filed on Nov. 16, 2021. The entirety of the above-mentioned patent application is hereby incorporated by reference herein and made a part of the specification.

### BACKGROUND OF THE INVENTION

### Field of the Invention

The disclosure relates to an electronic device and a connecting device connected to the electronic device.

### Description of the Related Art

Universal serial bus (USB) Type-C connecting devices are not different in the positive or negative specification design and have power, data, and image transmission functions simultaneously, and therefore are increasingly widely applied to various electronic products.

When power, data, or image transmission is performed, a framework of an existing USB Type-C connecting device first needs to perform protocol communication through a configuration channel, to set the format of power, data, or image. However, not all the USB Type-C connecting devices have all functions. When users connect such USB Type-C connecting devices that do not have all functions, a compatibility problem is encountered sometimes. As a result, the devices do not function as expected or work normally. However, the users generally have no USB Type-C analysis devices or instruments. Consequently, when the users encounter a connection problem of the USB Type-C connecting devices, the users usually cannot learn the content of the problem and cannot find a solution or ask for help.

### BRIEF SUMMARY OF THE INVENTION

According to the first aspect of the disclosure, an electronic device adapted to be electrically connected to a second electronic device through a connecting device is provided. The second electronic device includes a second USB Type-C port and a second power delivery controller. The electronic device includes a first USB Type-C port, a first power delivery controller, an analysis module, and a reminder device. The first USB Type-C port is electrically connected to the second USB Type-C port through the connecting device. The first power delivery controller is electrically connected to the first USB Type-C port, so that the first power delivery controller communicates with the second power delivery controller to generate transmission handshaking information through the first USB Type-C port, the connecting device, and the second USB Type-C port. The analysis module is electrically connected to the first power delivery controller, to determine at least one function type transmissible between the electronic device and the second electronic device according to the transmission handshaking information. The reminder device is electrically connected to the analysis module and used for indicating the function type supportable between the electronic device and the second electronic device.

According to the second aspect of the disclosure, a connecting device adapted to be electrically connected to a first electronic device and a second electronic device is provided. The first electronic device includes a first USB Type-C port and a first power delivery controller, and the second electronic device includes a second USB Type-C port and a second power delivery controller. The connecting device includes a first USB Type-C connector, a second USB Type-C connector, a transmission line, and a control chip. The first USB Type-C connector is connected to the first USB Type-C port. The second USB Type-C connector is connected to the second USB Type-C port. The transmission line is electrically connected to the first USB Type-C connector and the second USB Type-C connector, so that the first power delivery controller communicates with the second power delivery controller to generate transmission handshaking information through the first USB Type-C port, the first USB Type-C connector, the transmission line, the second USB Type-C connector, and the second USB Type-C port. The control chip is electrically connected to the transmission line, to receive the transmission handshaking information and determine at least one function type transmissible between the first electronic device and the second electronic device according to the transmission handshaking information.

To sum up, the disclosure provides the electronic device and the connecting device, where the devices obtain the function types transmissible between the electronic devices through the transmission handshaking information, to enable a user to learn a communication status and the function types transmissible between the connecting device and the electronic device, so as to take corresponding processing methods without using specific analysis devices or instruments, which is quite convenient to use.

### BRIEF DESCRIPTION OF THE DRAWINGS

FIG. 1 is a schematic block diagram of an electronic device according to an embodiment of the disclosure;

FIG. 2 is a schematic block diagram of an electronic device according to another embodiment of the disclosure; and

FIG. 3 is a schematic block diagram of a connecting device according to an embodiment of the disclosure.

### DETAILED DESCRIPTION OF THE EMBODIMENTS

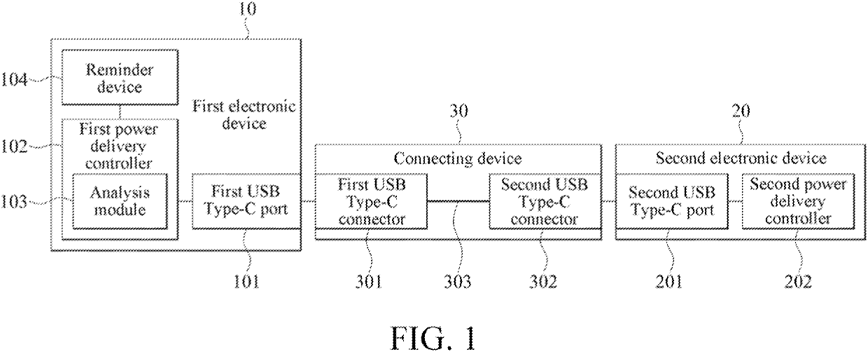

Referring to FIG. 1, an electronic device (referred to as a first electronic device 10 below) includes a first USB Type-C port 101, a first power delivery controller 102, an analysis module 103, and a reminder device 104. The first electronic device 10 is adapted to be electrically connected to a second electronic device 20 through a connecting device 30. The second electronic device 20 includes a second USB Type-C port 201 and a second power delivery controller 202 connected thereto. In the first electronic device 10, the first USB Type-C port 101 is electrically connected to the second USB Type-C port 201 through the connecting device 30, and the first power delivery controller 102 is electrically connected to the first USB Type-C port 101, so that the first power delivery controller 102 performs configuration channel protocol communication with the second power delivery controller 202 through the first USB Type-C port 101, the connecting device 30, and the second USB Type-C port 201, to generate transmission handshaking information through communication between the first power delivery controller 102 and the second power delivery controller 202. The analysis module 103 is electrically connected to the first power delivery controller 102. In this embodiment, the first power delivery controller 102 is a high-end electronic chip with functions of determining and controlling. Therefore, the analysis module 103 is built in the first power delivery controller 102. The analysis module 103 determines at least one function type transmissible between the first electronic device 10 and the second electronic device 20 according to the transmission handshaking information, such as a power transmission function, a data transmission function, an image transmission function, or any combination thereof. To make a user clearly learn the function type such as the power transmission function, the data transmission function, or the image transmission function that is supportable after the connecting device 30 is electrically connected to the first electronic device 10 and the second electronic device 20, the first electronic device 10 is also equipped with the reminder device 104 that is electrically connected to the analysis module 103. The reminder device 104 is used for indicating function types that are transmission-supportable or transmission-unsupportable between the first electronic device 10 and the second electronic device 20, for example, information such as the current transmissible and receivable voltage and power, the existing USB type, and the image transmission format.

As shown in FIG. 1, in an embodiment, the analysis module 103 built in the first power delivery controller 102 is a software component. The software component further includes a determining algorithm responsible for determining function types transmissible between the first electronic device 10 and the second electronic device 20 according to transmission handshaking information.

In an embodiment, the connecting device 30 includes a first USB Type-C connector 301, a second USB Type-C connector 302, and a transmission line 303. The transmission line 303 is electrically connected to the first USB Type-C connector 301 and the second USB Type-C connector 302, so that the first USB Type-C connector 301 is plugged in the first USB Type-C port 101 of the first electronic device 10, and the second USB Type-C connector 302 is plugged in the second USB Type-C port 201 of the second electronic device 20, to transmit signals.

In an embodiment, the first electronic device 10 is used as a primary electronic device, and the second electronic device 20 is used as a secondary electronic device. In an embodiment, the primary electronic device is a notebook computer or the like and the secondary electronic device is a liquid crystal display. When the first electronic device 10 (the notebook computer) is electrically connected to the second electronic device 20 (the liquid crystal display) through the connecting device 30 of the USB Type-C, the first power delivery controller 102 performs configuration channel protocol communication with the second power delivery controller 202 through the first USB Type-C port 101, the first USB Type-C connector 301, the transmission line 303, the second USB Type-C connector 302, and the second USB Type-C port 201, to generate the transmission handshaking information through communication and deliver the transmission handshaking information to the analysis module 103. The analysis module 103 determines according to the transmission handshaking information that the function types transmissible among the first electronic device 10, the connecting device 30, and the second electronic device 20 are the power transmission function and the image transmission function, so that the first electronic device 10 provides an acquired type of power (such as 5 volts, 9 volts, or 12 volts) to the second electronic device 20 and delivers a to-be-displayed image signal to the second electronic device 20, and the image signal is displayed on the second electronic device 20.

In another embodiment, the second electronic device 20 is used as a primary electronic device, and the first electronic device 10 is used as a secondary electronic device. In an embodiment, the primary electronic device is a liquid crystal display and the secondary electronic device is a notebook computer. When the second electronic device 20 (the notebook computer) is electrically connected to the first electronic device 10 (the liquid crystal display) through the connecting device 30 of the USB Type-C, the first power delivery controller 102 performs configuration channel protocol communication with the second power delivery controller 202 through the first USB Type-C port 101, the first USB Type-C connector 301, the transmission line 303, the second USB Type-C connector 302, and the second USB Type-C port 201, to generate the transmission handshaking information through communication and deliver the transmission handshaking information to the analysis module 103. The analysis module 103 determines according to the transmission handshaking information that the function types transmissible among the first electronic device 10, the connecting device 30, and the second electronic device 20 are the power transmission function and the image transmission function, so that the second electronic device 20 provides an acquired type of power to the first electronic device 10 and delivers a to-be-displayed image signal to the first electronic device 10 and the image signal is displayed on the first electronic device 10.

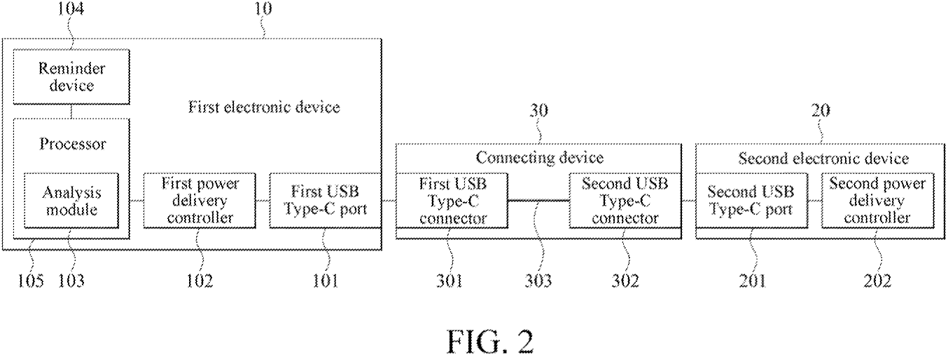

Referring to FIG. 2, a first electronic device 10 includes a first USB Type-C port 101, a first power delivery controller 102, an analysis module 103, and a reminder device 104, and a processor 105. The first electronic device 10 is adapted to be electrically connected to a second electronic device 20 through a connecting device 30. The second electronic device 20 includes a second USB Type-C port 201 and a second power delivery controller 202 connected thereto. In the first electronic device 10, the first USB Type-C port 101 is electrically connected to the second USB Type-C port 201 through the connecting device 30, and the first power delivery controller 102 is electrically connected to the first USB Type-C port 101. The first power delivery controller 102 performs configuration channel protocol communication with the second power delivery controller 202 through the first USB Type-C port 101, the connecting device 30, and the second USB Type-C port 201, to generate transmission handshaking information through communication between the first power delivery controller 102 and the second power delivery controller 202. The processor 105 is electrically connected to the first power delivery controller 102. In this embodiment, the analysis module 103 is built in the processor 105. The analysis module 103 in the processor 105 determines one or more function types transmissible between the first electronic device 10 and the second electronic device 20 according to the transmission handshaking information. The reminder device 104 is electrically connected to the processor 105, to indicate function types that are transmission-supportable or transmission-unsupportable between the first electronic device 10 and the second electronic device 20 according to a determination result of the analysis module 103. Excluding component relationships and actions described herein, other characteristics are the same as those in the embodiment shown in FIG. 1. Therefore, reference is made to the foregoing description and details are not described herein again.

In an embodiment, the processor 105 is but not limited to a central processing unit (CPU), a microprocessor, a digital signal processor (DSP), an application-specific integrated circuit (ASIC), a system on a chip (SOC), or another similar component, or a combination thereof.

As shown in FIG. 2, in an embodiment, the analysis module 103 built in the processor 105 is a software component. The software component further includes a determining algorithm responsible for determining function types transmissible between the first electronic device 10 and the second electronic device 20 according to transmission handshaking information.

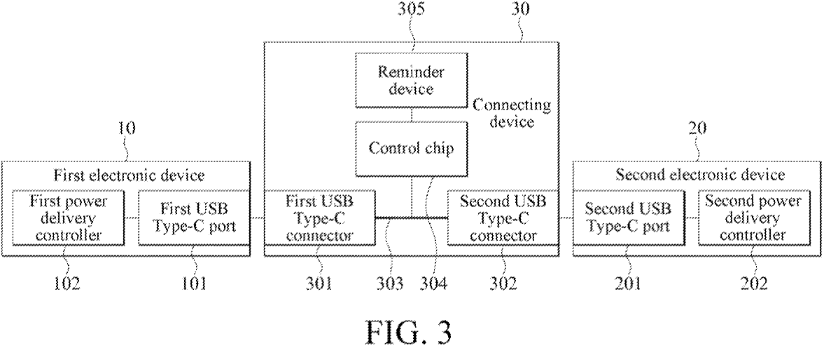

Referring to FIG. 3, a connecting device 30 is adapted to be electrically connected to a first electronic device 10 and a second electronic device 20. The first electronic device 10 includes a first USB Type-C port 101 and a first power delivery controller 102, and the first USB Type-C port 101 is electrically connected to the first power delivery controller 102. The second electronic device 20 includes a second USB Type-C port 201 and a second power delivery controller 202, and the second USB Type-C port 201 is electrically connected to the second power delivery controller 202. The connecting device 30 includes a first USB Type-C connector 301, a second USB Type-C connector 302, a transmission line 303, a control chip 304, and a reminder device 305. The first USB Type-C connector 301 is connected to the first USB Type-C port 101. The second USB Type-C connector 302 is connected to the second USB Type-C port 201. The transmission line 303 is electrically connected to the first USB Type-C connector 301 and the second USB Type-C connector 302. The first power delivery controller 102 performs configuration channel protocol communication with the second power delivery controller 202 through the first USB Type-C port 101, the first USB Type-C connector 301, the transmission line 303, the second USB Type-C connector 302, and the second USB Type-C port 201, to generate transmission handshaking information through communication between the first power delivery controller 102 and the second power delivery controller 202. The control chip 304 is electrically connected to the transmission line 303, to obtain, from the transmission line 303, the transmission handshaking information generated after communication between the first power delivery controller 102 and the second power delivery controller 202. The control chip 304 determines function types transmissible between the first electronic device 10 and the second electronic device 20 according to the transmission handshaking information. The reminder device 305 is electrically connected to the control chip 304. After the control chip 304 determines the transmissible function types, the reminder device 305 indicates the function types supportable between the first electronic device 10 and the second electronic device 20, to display the function types to a user.

When the first USB Type-C connector 301 of the connecting device 30 is plugged in the first USB Type-C port 101 of the first electronic device 10 and the second USB Type-C connector 302 is plugged in the second USB Type-C port 201 of the second electronic device 20, the first electronic device 10 performs configuration channel protocol communication with the second electronic device 20 through the connecting device 30, so that the first power delivery controller 102 communicates with the second power delivery controller 202 to obtain corresponding transmission handshaking information. The control chip 304 determines function types transmissible between the first electronic device 10 and the second electronic device 20 according to the transmission handshaking information, and the function types supportable between the first electronic device 10 and the second electronic device 20 are provided to the user through the reminder device 305.

As shown in FIG. 3, in an embodiment, the first electronic device 10 is used as a primary electronic device and the second electronic device 20 is used as a secondary electronic device; or the second electronic device 20 is used as a primary electronic device and the first electronic device 10 is used as a secondary electronic device.

As shown in FIG. 3, in an embodiment, a software component is further installed in the control chip 304. The software component further includes a determining algorithm responsible for determining function types transmissible between the first electronic device 10 and the second electronic device 20 according to the transmission handshaking information or other related operations.

Referring to FIG. 1, FIG. 2, and FIG. 3 together, the reminder devices 104 shown in FIG. 1 and FIG. 2 and the reminder device 305 shown in FIG. 3 are a lighting device, a sound device, or a display device, to indicate the function types supportable between the first electronic device 10 and the second electronic device 20 in the form of light, sound, or display, to enable a user to easily learn function types of a combination system of the first electronic device 10, the connecting device 30, and the second electronic device 20 that are currently connected. In an embodiment, when the reminder device 305 is the lighting device, using light emitting diodes as light signals for display, different light signals in different colors are used to indicate different function types, to enable the user to learn function types that are supportable or unsupportable in the whole combination system by emitting the light signals in different colors. When the reminder device 305 is the sound device, different sounds are made to indicate different function types, or speeches are directly used to broadcast the function types that are supportable or unsupportable in the combination system. When the reminder device 305 is the display device, the display device directly displays texts of the function types that are supportable or unsupportable or every function type has a representation icon, so that the display device directly displays the representation icons of the function types that are supportable, to enable the user to easily learn the function types that are applicable in the whole combination system.

In the foregoing embodiments, based on the disclosure, by reading the transmission handshaking information by means of delivery or retrieval on the first electronic device or the second electronic device connected to the connecting device or the connecting device located on a transmission path to perform analysis, the communication status or the existing function types of the whole connecting system (including the first electronic device, the connecting device, and the second electronic device) are obtained accordingly.

To sum up, the disclosure provides the electronic device and the connecting device, where the devices obtain the function types transmissible between the electronic devices through the transmission handshaking information, to enable a user to learn a communication status and the function types transmissible between the connecting device and the electronic device, so as to take corresponding processing methods without using specific analysis devices or instruments, which is quite convenient to use.

The foregoing embodiments are merely for describing the technical ideas and the characteristics of the disclosure, and are intended to enable those skilled in the art to understand and hereby implement the content of the disclosure. However, the scope of claims of the disclosure is not limited thereto. In other words, equivalent changes or modifications made according to the spirit disclosed in the disclosure shall still fall into scope of the claims of the disclosure.

What is claimed is:

1. An electronic device, adapted to be electrically connected to a second electronic device through a connecting device, the second electronic device comprising a second universal serial bus (USB) Type-C port and a second power delivery controller, wherein the electronic device comprises:
a first USB Type-C port, electrically connected to the second USB Type-C port through the connecting device;
a first power delivery controller, electrically connected to the first USB Type-C port, so that the first power delivery controller communicates with the second power delivery controller to generate transmission handshaking information through the first USB Type-C port, the connecting device, and the second USB Type-C port;
an analysis module, electrically connected to the first power delivery controller, wherein the analysis module determines at least one function type transmissible between the electronic device and the second electronic device according to the transmission handshaking information; and
a reminder device, electrically connected to the analysis module and used for indicating the at least one function type supportable between the electronic device and the second electronic device.

2. The electronic device according to claim 1, wherein the analysis module is built in the first power delivery controller.

3. The electronic device according to claim 1, further comprising a processor, electrically connected to the first power delivery controller, wherein the analysis module is built in the processor.

4. The electronic device according to claim 1, wherein the function type is a power transmission function, a data transmission function, an image transmission function, or any combination thereof.

5. The electronic device according to claim 1, wherein the reminder device is a lighting device, a sound device, or a display device.

6. The electronic device according to claim 1, wherein the electronic device is a primary electronic device, and the second electronic device is a secondary electronic device.

7. The electronic device according to claim 1, wherein the electronic device is a secondary electronic device, and the second electronic device is a primary electronic device.

8. A connecting device, adapted to be electrically connected to a first electronic device and a second electronic device, the first electronic device comprising a first universal serial bus (USB) Type-C port and a first power delivery controller, and the second electronic device comprising a second USB Type-C port and a second power delivery controller, wherein the connecting device comprises:
a first USB Type-C connector, connected to the first USB Type-C port;
a second USB Type-C connector, connected to the second USB Type-C port;
a transmission line, electrically connected to the first USB Type-C connector and the second USB Type-C connector, so that the first power delivery controller communicates with the second power delivery controller to generate transmission handshaking information through the first USB Type-C port, the first USB Type-C connector, the transmission line, the second USB Type-C connector, and the second USB Type-C port; and
a control chip, electrically connected to the transmission line, to receive the transmission handshaking information and determine at least one function type transmissible between the first electronic device and the second electronic device according to the transmission handshaking information.

9. The connecting device according to claim 8, further comprising a reminder device, electrically connected to the control chip and used for indicating the at least one function type transmissible between the first electronic device and the second electronic device.

10. The connecting device according to claim 9, wherein the reminder device is a lighting device, a sound device, or a display device.

11. The connecting device according to claim 8, wherein the function type is a power transmission function, a data transmission function, an image transmission function, or any combination thereof.
